(19) United States
(12) Patent Application Publication
(10) Pub. No.: US 2026/0087517 A1
(43) Pub. Date: Mar. 26, 2026

(54) Systems and Methods for Operating and Regulating Recommender Systems

(71) Applicant: Brian David McFadden, Miami, FL (US)

(72) Inventor: Brian David McFadden, Miami, FL (US)

(21) Appl. No.: 19/245,401

(22) Filed: Jun. 23, 2025

(51) Int. Cl. G06Q 30/0251

(52) U.S. Cl. CPC G06Q 30/0254

(57) ABSTRACT

The new methods and mechanisms disclosed are useful in the context of information exchange systems that facilitate a flow of information items from information producers to information consumers, for example, social networks, online publishing systems, ad networks, and Recommender Systems in general. The new systems and methods improve the precision for determining the bounds on a set of items that may be included in the information stream of the information consumer, and improve consumer participation. The improvements also provide additional support for handling new metadata attributes.

### CROSS-REFERENCE TO RELATED APPLICATIONS

This application claims the benefit of provisional patent application No. 63/69,8967 filed Sep. 25, 2024 by Brian D. McFadden.

### TECHNICAL FIELD

This patent application relates generally to operating a specialized computer system and regulating the flow of information or content in these systems. The improvements disclose here in this Specification, include refinement of the control mechanisms that determine the precise flow of information items in the information stream of the information consumer. Applications of the systems and method include for example Recommender Systems in general, Social Networks, Ad Networks, Online Publishers and other systems that facilitate a flow of information items from information producers to information consumers.

The underlying subsystems use machine learning, statistical methods, artificial intelligence, and other techniques to create the metrics and parameters needed to support the methods and systems that provide additional intelligence for the operating and regulating functions.

### BACKGROUND

This patent application provides new and useful improvements to the prior art including the patent applications of the inventor, U.S. patent application Ser. No. 14/215,034 and 15/891,363.

### BRIEF DESCRIPTION OF DRAWINGS

FIG. 1. Describes an illustrative example diagram of an information exchange system including distributor and distributor subsystem.

FIG. 2. Describes a further illustrative example diagram of the data flow of user profile and selection criteria into the distributor subsystem.

FIG. 3A. Describes an illustrative example diagram of the distributor subsystem with predicted information items.

FIG. 3B. Describes an illustrative example diagram of the distributor subsystem with candidate information items.

FIG. 4. Describes an illustrative example system diagram for determining a star distribution data structure.

FIG. 5. Describes an illustrative example system diagram for generating a carve-out distribution data structure.

FIG. 6. Describes an illustrative example diagram of a process for determining a D* distribution with consideration of the slope metric between D* and D′.

FIG. 7. Describes an illustrative example diagram of a process for generating a carve-out distribution.

FIG. 8. Describes an illustrative example flow diagram of a process for determining a D* distribution with illustrative example variations and consideration of a slope metric between D* and D′.

FIG. 9. Describes an illustrative example diagram of a process for generating a carve-out distribution with illustrative example variations.

FIG. 10. Describes an illustrative example of a priority grid with include region and threshold boundary.

### DETAILED DESCRIPTION

### Base System Infrastructure

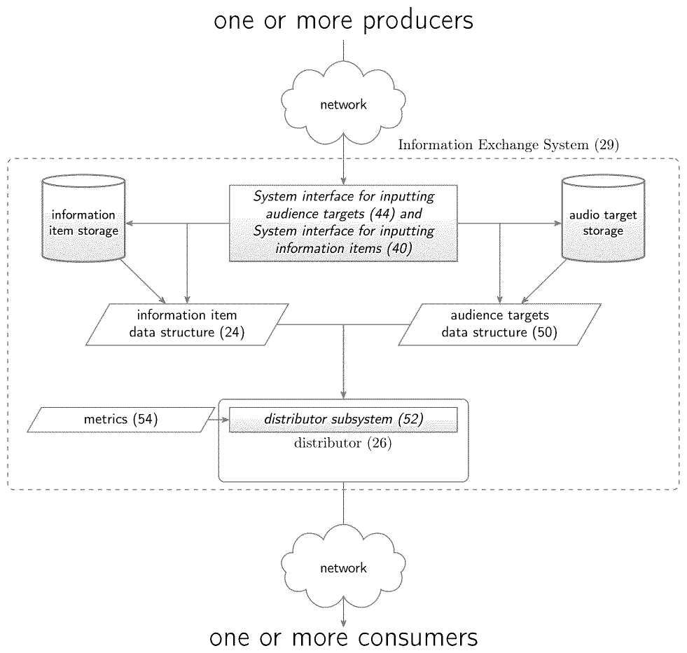

An example of an information exchange system 29 and the parts of the information exchange system is shown in FIG. 1. A user of the information exchange 29 may be either an information producer or an information consumer or both.

In general the information exchange system 29 delivers an information item 24 from the information producer to the information consumer. A basic information exchange system 29 has a distributor 26 that specifies how the information items flow from producer to consumer.

The distributor 26 can take multiple forms, for example an information switch including simple pass through, publisher to consumer, sender to receiver, publish-subscribe, or other form where the information item is optionally transferred from a producer to a consumer over a network. The distributor 26 would include for example cases where the consumer friends or follows one or more producers or joins a group or where a producer and consumer have agreed to follow or friend or exchange information with each other and allow the other party to do the same. The distributor 26 may support subscriptions or not. If subscriptions are supported, the consumer may be subscribed to one, several or all producers. If the distributor 26 does not support subscriptions the consumer will be able to receive from all producers. There may be one or multiple producers. There may be one or multiple consumers. Some examples of the information exchange 29 are a social network, a group within a social network, a list server, a forum, a publishing system, a content management system, a news aggregation service, a news feed, a newsletter, a digest, offers, alerts, an ad exchange, an ad network, email client, news reader, web browser, portal, AI agent, chat server, Recommender systems, recommendation services, support status messaging, or any service that facilitates a flow of information items from producers to consumers.

The producer is the user who will send, post, place, contribute, publish, author, create, direct, respond, or otherwise cause information to be distributed to, made available by, or made viewable by, one or more other users of the information exchange.

The information consumer is the user who will receive information items originating from the producers. The consumer may or may not consume the information items made available to them.

Note that the labels producer and consumer are relative to information or content production and information or content consumption and in no way imply a commercial relationship.

The information item 24 can be a message, email, notice, response, video clip, audio clip, news, article, story, solicitation, thread, post, reply, comment, offer, advertisement, URL, or any other form of communication that can be sent or made available by a producer to a consumer via a network, for example a private or public data network.

The users of the information exchange system may connect to the information exchange 29 via a network using a network connected communication device 87 that is capable of communication via the network connected to the information exchange system 29. The communication may be for example via network packets representing binary data, text, or audio or other related forms serving a similar connection and communication purpose. The data and may be compressed. The device 87 may be for example a dumb terminal, a mobile device, a personal computer, or an embedded bio connected transmitter.

As shown in FIG. 1, a system interface for inputting the information item 40 receives an information item 24 from the producer.

An information stream 25 is a collection or set of information items delivered sequentially or together to a consumer, either directly or embedded, via a medium including, but not limited to, email, web feeds, mobile messaging, video, audio, broadcast, or via any other means of delivering information.

Audience targets 50, for example, define a set of consumers or audiences that a producer would like to reach or not reach. In FIG. 1, a system interface for inputting the audience targets 44 receives audience target data 50.

As in FIG. 1, the information items data structures 24 and audience target data structures 50 move on to a distributor subsystem, and depending on processing in the distributor subsystem 52 using at least some of the data available to the distributor subsystem the information item 24 may or may not be added to the information stream 25 for a particular consumer.

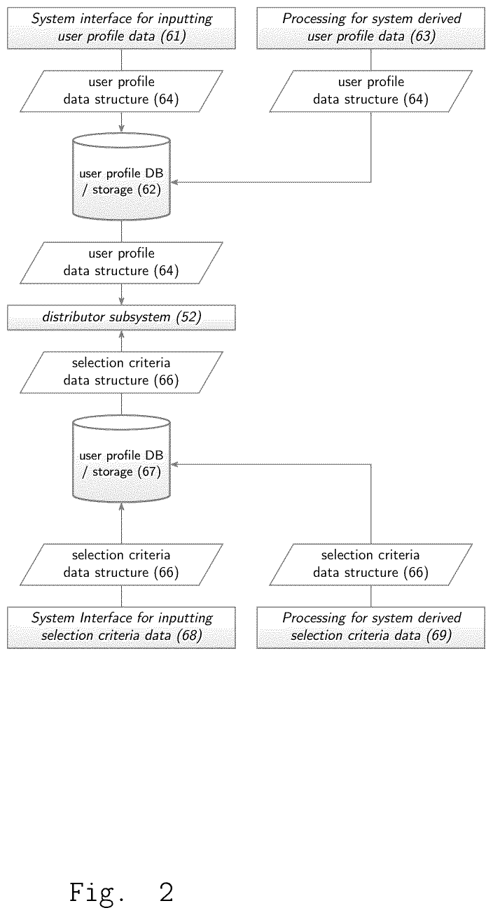

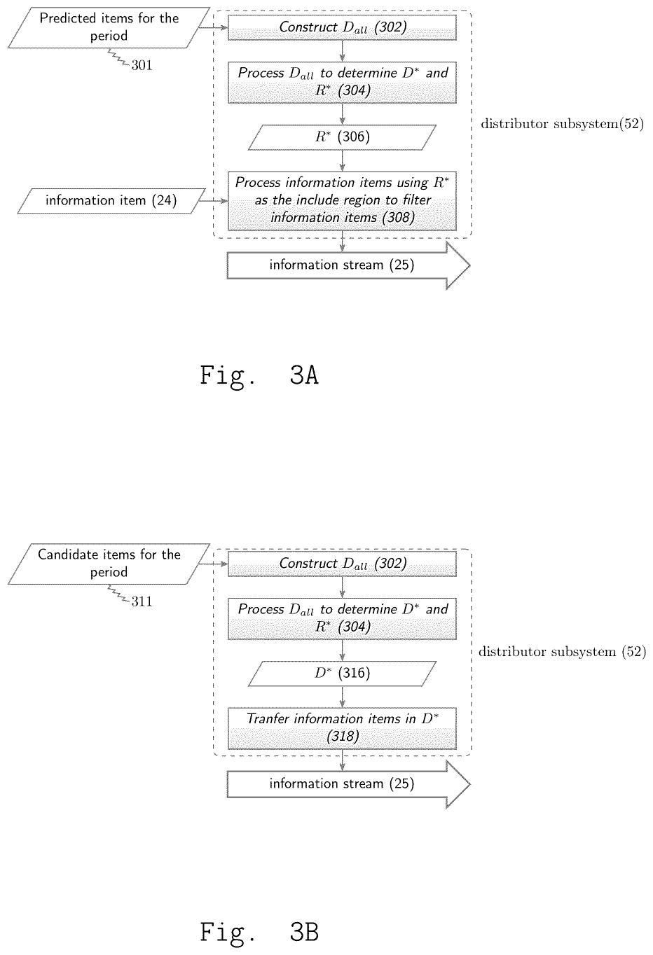

FIG. 1 is not intended to show every detail of the information flow. Some of the additional details of the data flow are provided in FIG. 2, FIGS. 3A and 3B.

The system interface for inputting the audience targets may interact with a producer limits control loop 46 and may interact with an audience target request control loop 48. The producer limits control loop 46 and the audience target request control loop 48 regulate the audience targets 50 included with an information item 24 to be processed by a distributor subsystem 52.

A meta data request control loop 42 may interact with the system interface for inputting the information item 40 and regulates the amount of additional descriptive data that is collected when an information item 24 is entered.

In FIG. 2 shows an example of part of the information exchange 29 where user 20 may enter user profile data 64 into a system interface for inputting the user profile 61. The system interface for inputting the user profile 61 stores the user profile data structure 64 in a user profile database or storage 62. The user profile storage 62 may be an internal part of the information exchange, external to the information exchange, or a combination of internal and external. System derived user profile data 63 can also be stored as a user profile data structure 64 in the user profile storage 62. In some configurations, the user may not input any user profile data.

A user profile includes available information, not limited to form, about the user. This includes but is not limited to behavior, biographic, demographic, historical, ratings, feedback, tracking, or other general or specific information from sources internal and external to the information exchange 29 and represented in user profile data structures 64. The form for the user profile storage may include, for example, relational database, name value pair, no-sql, hierarchical data, objects, nested objects, nested hierarchical data, or combination of databases in a single source or in multiple sources. The data may be stored, for example, in computer memory, magnetic disk, or flash memory. In some embodiments data is stored in a non-transitory, computer-readable storage media. If accessible via an API the user profile data structures 64 may be represented, for example, by XML, JSON, BSON, name value pairs, CVS, or any other appropriate data representations.

In FIG. 2 a system interface for inputting the selection criteria 68 stores a selection criteria data structure 66 in a selection criteria storage 67. The selection criteria data structure 66 may indicate the type or set of information items that the consumer is potentially interested in or not interested in receiving. The selection criteria storage 67 can be internal to the information exchange 29, external to the information exchange 29, or a combination of internal and external. The selection criteria 66 can also include a system derived selection criteria data 69 that can also be stored in the selection criteria storage 67.

In some embodiments, the selection criteria data structure 66 may be stored with the user profile data structure 64 and the user profile storage 62 and selection criteria storage 67 may be the same.

In some embodiments, the selection criteria storage 67 and user profile storage 62 may be stored together on contiguous storage for fast access and processing.

The distributor subsystem 52 processes the information item 24, audience targets 50, a set of metrics 54, user profiles from the user profile storage 62, and selections criteria from the selection criteria storage to determine what consumers should get, receive, have access or availability to, or view the information item as described below. The metrics 54 may be measures, statistics, and parameters obtained, in direct or computed form, from one or more sources internal or external to the information exchange.

In some embodiments, the distributor subsystem 52 and the distributor 26 may operate on the same computer system. In some embodiments, the distributor subsystem 52 and the distributor 26 may operate on separate networked computer systems. Additional details of the distributor subsystem 52 are provided in the illustrative example in FIG. 3A and FIG. 3B.

### Operational Description

The systems described here are computer coded software operating as the information exchange or an integral part of the information exchange. In some embodiments, the systems will exist separately from the information exchange as a sub-system interacting with the information exchange as detailed below.

The information exchange system is a specially configured computer system that operates on a computer network or a network of computer systems or on special hardware.

The information exchange system and the systems described here will be operational on computer hardware that includes combinations of one or more physical computer hardware systems, physical servers, devices, mobile devices, CPUs, auxiliary CPUs, embedded processors, circuits, workstations, desktop computers, virtual devices, virtual servers, virtual machines, or similarly related hardware or future hardware performing similar functions and replacing any of the above mention hardware and hardware combinations, with an applicable operating system appropriate for the specific hardware, and in the case of more than one, interconnected via a private or public network.

In some embodiments, the processing unit hardware of the computer hardware systems may be coupled with memory containing the programmable instructions to implement the systems and methods described here.

In some embodiments, the system may operate as a self regulated or automatic control system.

Each process described in this disclosure or illustrated in figures represents a sequence of operations that can be implemented in hardware, software, or a combination thereof. In the context of software, the operations represent computer-executable instructions stored on one or more computer-readable media or embodied as one or more computer transmission media that, when executed by one or more processors, perform the recited operations. Generally, computer-executable instructions include routines, programs, objects, components, data structures, and the like that perform particular functions or implement particular data types.

### The Producer

The producer may enter the information item 24 into a system interface for inputting the information item 40. The information item includes of contents and a meta description or meta data, and is represented in the system as a data structure. The contents may include for example, summary, title, full story, image, video, audio, rich media, or other information delivery objects. The meta description may include for example, abstract, source, keywords, authors, bylines, related links, topics, subjects, types, restrictions, pricing, or other fields. The information item data structure includes fields, objects, and hierarchical data used to classify, categorize, track, identify or otherwise describe the contents and the information item, and to provide other metrics related to the information item. In some embodiments, the meta data description and the information item may be the same.

The producer may enter the audience target into the system interface for inputting the audience targets 44. The audience target describes the consumers that the producer would like to reach or not reach. The specification of an audience target can reference any aspect of the user profile to specify the audience. The audience target will have an action to specify if it is desired by the producer for the user matching the audience target to receive the information or not. The action may indicate indifference to the matching user receiving it. In some embodiments, the default action may be indifference. In some embodiments, the system interface for inputting the information item and the system interface for inputting the audience targets may be the same.

In some embodiments, the producer may specify one or more additional audience targets that they want.

In some embodiments, the producer may construct an audience target and priority by selecting one or more parameters from available data in the user profile of the consumer and assign a priority to values for each discrete parameters and range of values for continuous parameters. The max and min values for all combination of field values may be used to determine a normalized priority scale.

In some embodiments, the producer may have an archive of predefined audience targets that can be selected instead of entering and creating new audience targets.

The information items and audience targets may be sent to a distributor subsystem. In some embodiments, the distributor subsystem may be integral with the information exchange distributor. In some embodiments, the distributor subsystem can be external to the information exchange distributor.

In some embodiments, producers may use visual input sliders to indicate audience targets and priorities for specific profile attributes. For example, an audience target with higher priority targets based by years of experience of the consumer. In some embodiments, producers may use drag and drop visuals to rank audience targets and set audience target priorities.

In some embodiments, the producer's entered audience target may be applied to single information item, multiple information items, or all information items from that producer.

In some embodiments, the producer may be an autonomous agent.

### The User

In some embodiments, the user, producer and consumer, may enter data into the user profile 61. The user profile 61 may also include system data and information about the user including, but not limited to, performance, behavioral, history, tracking, or any other information that the system can record or compute for a user. In some embodiments, the user profile may also include external information obtained from external systems. For example, performance, behavioral, history, tracking, records, or any other information that can be obtained or computed from external systems or combined with internal profile data. In some embodiments, the user profile may have data from all data sources.

The information exchange user 20 may enter user profile data 64 into a system interface for inputting the user profile 61. The system interface for inputting the user profile 61 stores the user profile data 64 in a user profile storage 62. In some embodiments, the user profile storage may be part of the information exchange 29. In some embodiments, the user profile storage 62 may be external to the information exchange 29. In some embodiments, the user profile storage 62 may be distributed between the information exchange 29 and external to it. In some embodiments, external and system derived user profile data 63 may be stored in the user profile storage 62.

### The Consumer

In some embodiments, the consumer may enter the selection criteria that defines the type of information item and may also define a type of producer. In some embodiments, the selection criteria may only specify a type of information item or type of producer. In some embodiments, the consumer may enter an action for the selection criteria to specify if the information items matching the criteria are items they would want to receive or not receive. In some embodiments, the action may indicate indifference to receiving it. In some embodiments, the default action may be indifference. In some embodiments, the action assigned to the selection criteria may be assigned by the system from behavior actions of the consumer. For example, by the consumer expressing interest in an a related item or meta data topic.

The consumer may enter more than one selection criteria. If more than one selection criteria is specified the consumer may specify a priority to define how important the criteria is. Priorities can be expressed by ordering the criteria or by selecting a priority preference input. In some embodiments, the priority of the selection criteria may be assigned by the system from the context of the inputted or derived selection criteria or the behavior, history, or actions leading to the creation of the selection criteria.

In some embodiments, selection criteria and priority for the selection criteria may be determined from performance, historical, behavioral, or tracking data of the consumer. In some embodiments, selection criteria and priority may be determined from predictive statistical methods. In some embodiments, selection criteria entered by the consumer may be combined with selection criteria determined from all other means.

In some embodiments, priorities may be set by the system for each selection criteria. In some embodiments, the system sets a default priority for the selection criteria that can be changed by the consumer.

In some embodiments, the processing of the consumers selection criteria may be integral with the information exchange distributor. In some embodiments, the processing may be external to the default distributor.

In some embodiments, the consumer's selection criteria may be entered by a human. In some embodiments, the selection criteria may be entered by an autonomous agent.

The consumer may enter the selection criteria into a system interface for inputting the selection criteria. The system interface for inputting the selection criteria 68 stores the selection criteria in a selection criteria storage 67. In some embodiments, the selection criteria storage 67 may be part of the information exchange. In some embodiments, the selection criteria storage 67 may be external to the information exchange. In some embodiments, the selection criteria storage 67 may be distributed between the information exchange and external to it. In some embodiments, system derived selection criteria 69 may be stored in the selection criteria storage 67.

In some embodiments, consumers use drag and drop visuals to rank selection criteria and set selection criteria priorities.

In some embodiments, the consumer may be an autonomous agent specific to an information consumer. In some embodiments the autonomous agent may be an aggregator of content from multiple producers or different sources. In some embodiments the autonomous agent may be the information exchange.

### Information Stream

For each information item 24 processed, a consumer priority may be obtained from the consumer's selection criteria 65, and a producer priority may be obtained from the audience targets 50 for that information item.

Different ranges of priority levels may be assigned to audience targets 50 or selection criteria 66. The priority scale, for example, may be infinite or fixed or normalized, for example normalized to the zero to one interval.

The actions for do-not-want and do-not-send may multiply their priorities by −1. When there is no applicable audience target or the action is indifference, the producer priority may be represented by 0. When there is no applicable selection criteria or the action is indifference, the consumer priority may be represented by 0.

For each information item and information consumer there may be an information item value pair. The information item value pair includes two metrics. One of the metrics represents the value or priority of the information item to the consumer. The other metric represents the value or priority to the information producer if the information item is consumed by the information consumer. A possible information item value pair indicates any metric pair within range whether there is an information item having that pair or not. A region represents a set of possible information item value pairs.

An include region may be used to determine what information items should be included in the information stream of the information consumer. The include region represents a set of producer priority and consumer priority pairs, or equivalently a set of producer item value and consumer item value pairs, or equivalently a set of possible information item value pairs. The set of pairs may be contiguous. The include region may be specified by a range or ranges for pair values. The include region may be defined by a threshold line or threshold boundary. An exclude region may specify the region outside of the include region.

A special process may be used to determine if the information item 24 with the producer priority and consumer priority pair, or equivalently the information item value pair, is included in or excluded from the information stream using the include region. The parameters for the special process may be computed from metrics.

### Priority Grid

A priority grid 70 may represent a range of combinations of producer priority and consumer priority or equivalently a range of information item value pairs. The priority grid 70 may be a continuous or discrete, or a combination of discrete and continuous. The priority grid may also be referred to as a decision matrix or decision grid. The priority grid in some cases will be equivalent to a mathematical set of points contained within a range of values for producer priority and consumer priority. A region of the priority grid would be a sub section of the grid or equivalently a sub set of points.

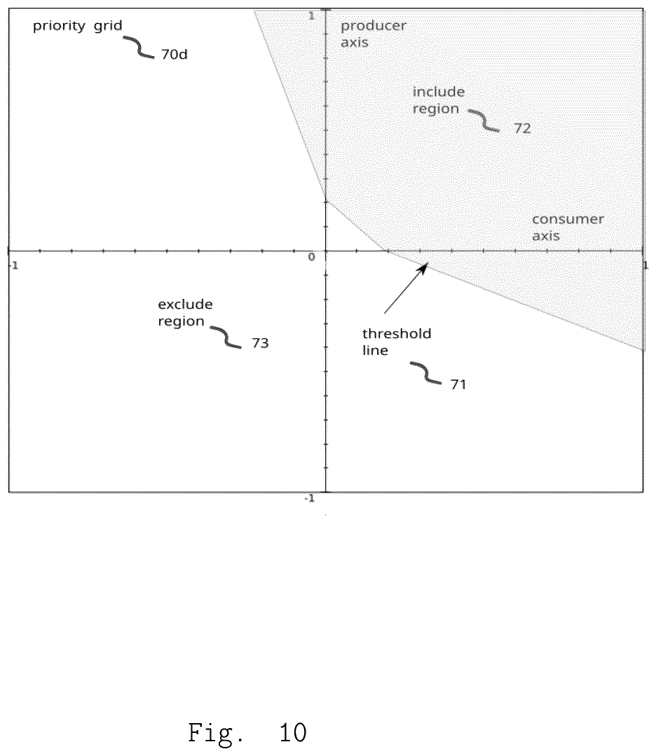

As an example, a sample priority grid is shown in FIG. 10. Mechanically the priority grid may be represented in any number of ways via data structure in the memory or storage of a computer system.

The priority grid 70 may be represented as a two dimensional interval with a range of [1, −1] for each dimension. The two dimensional interval is equivalent to any non-normalized two dimensional interval. The threshold boundary 71 separates the interval into the include region 72 and the exclude region 73. The priority grid 70 may be used to determine if the information item 24 should be included in the information stream of the consumer.

In the discrete case the threshold may be a set of cells that form the boundary of the include region 72 and exclude region 73. For example, the threshold set would be the boundary along any row or column in the priority grid 70 where there is a switch from include to exclude. A range or subset of the priority grid 70 is a set of cells or regions in the two dimensional interval.

The threshold line or boundary may be derived from the metrics 54 and may be represented by a threshold function, map, mapping, or relation. There may be a priority bounds in the priority grid or decision matrix where the threshold line may not cross.

The exclude region 73 may be divided into a reachable exclude range and a non-reachable exclude range. The reachable exclude range may be defined as the part of the exclude region below the threshold line 71. The reachable exclude range may also be defined as the part of the exclude range that may be reached by the producer, if the producer can increase the priority of the audience target matching that consumer.

In some embodiments, if the information item with information item value pair represented by a point on the priority grid 70d that is within the include region 72 defined by the threshold line 71 for the consumer, the information item is included in the consumer's information stream.

A discrete priority grid 70 may be constructed from ranges for producer priority and consumer priority by dividing the ranges into discrete points. For example, if the priority ranges are on the [1, −1] interval, dividing the ranges into 10ths would yield 20×20 or 400 discrete points.

### Metrics

The metrics are measures and parameters that may be internal to the information exchange or external to it. For example internal metrics may include metrics related to producer, consumer, system information flow, or the information exchange in general. For example. external metrics may include indications of important sporting events occurring that day, severe weather, day of week, political or business events occurring, measures of news and information flow or activity external to the information exchange, flow activity on external information exchanges, historical projections, statistics, or any other relevant data.

In some embodiments, the processing of the metrics may be integral with the information exchange 29 default distributor 26. In some embodiments, the processing of of the metrics may be external to the default distributor 26. In some embodiments, the processing of the metrics may be distributed between the default distributor and an external system.

In some embodiments, metrics computed, determined, or obtained for the information consumer, may be a specified individual information consumer or a representative information consumer. The representative information consumer may include representative data and metrics needed to compute or determine additional metrics.

A consumer participation metric may be used as a measure of information item consumption or interaction with the information item 24. The consumer participation metric may be obtained or computed from views, swipes, interactions, clicks, opens or any other applicable indicator of information item consumption by the consumer and useful to the information exchange. In some embodiments the participation metric may be measured. In some embodiments the participation metric may be estimated.

In some embodiments, the participation metric may be a measure of the number of items consumed or participated in for a specified period.

A participation rate for the information consumer may be measured as the number of information items participated in divided by the number of information items delivered or sent or made available to the consumer over a specified period (for example a day, week, month).

The participation rate may be obtained from other sources including surveys, monitoring, or other internal and external metrics.

An historical participation rate may be computed for each consumer. The historical participation rate can be computed in multiple ways from prior participation of the consumer. For example, using weighted history, rolling average or other computations. Multiple measures of historical participation may be used.

A consumer item value for the information item may be estimated for the consumer using the priority established from the selection criteria of the consumer. The priority of the information item may be the highest priority of matching selection criteria. In some embodiments, the consumer item value may be computed from the priority of overlapping selection criteria. In some embodiments, the consumer item value may be computed from the priority and other metrics.

A mapping of priority to value for the consumer may be used. In some embodiments, the consumer item value and priority may be assumed to be equivalent.

An average consumer item value may be computed for a period of time. For example, the average consumer item value may be computed as the sum of the consumer item value for items participated in for the period divided by the number of items participated in for the period. In some embodiments, a weighted average may be used to compute the average consumer item value with weights depending on information item meta data or other metrics. In some embodiments, the average consumer item value may be computed from other appropriate statistical techniques or norm. In some embodiments, a historical time series of average consumer item value may be computed and used.

In some embodiments, a consumer expected item value for an information item the consumer has not yet received is determined or estimated from metrics. For example, the historical time series of average consumer item value may be used as an estimate of the consumer expected item value. Multiple formula specific to the information exchange can be used for this estimate. For example using weighted history, rolling average or other computations. The consumer expected item value may be computed from the historical average consumer item value and other metrics, or may be obtained from, surveys, sentiment analysis, or other metrics.

A predictive participation rate may be computed. The predictive participation rate may be derived from statistical or predictive analytics using the historical participation rate and internal and external metrics and signals. In some embodiments, the predictive participation rate may be the same as the historical participation rate.

A participation prediction map 115 may be used to relate the consumer expected item value to a predicted participation level. The predicted participation level may represent a number of information items per specified period. The participation prediction map 115 may be a discrete, continuous, or mixed logical function or mapping. In some embodiments, statistical methods appropriate to the information exchange may be used to compute or derive a predictive participation formula or mapping using the consumer expected item value and additional internal or external metrics or signals. In some embodiments, the participation prediction map 115 may be determined using metrics from other consumers.

An inverse participation prediction map 116 may be used to relate the participation level to an expected item value.

A producer item value per consumer represents the value to the producer for the consumer to receive and consume an information item. The producer item value may be computed, for example, using the priority established from the audience targets for that information item. In some embodiments, the producer item value for a consumer may be computed from the audience target priority or other metrics.

In some embodiments, a mapping of priority to the producer item value per consumer may be used. In another embodiment, the producer item value and priority may be assumed equivalent. In some embodiments, a producer priority transformation 114 for mapping or relating producer priory to producer item value is used. Numerous transformations can be used as appropriate for the information exchange and including an identity transformation whereby producer priority and producer item value are equivalent. In some embodiments, composites of transformations are used.

A distribution of information items 121 is frequency distribution over a range, interval, region, or space. In some embodiments, the distribution 121 may be over one dimension or there may only be one value for all but one of the dimensions. The dimensions, for example, may be consumer priority and producer priority or consumer item value and producer item value. Equivalently the distribution 121 may be over a two dimensional interval or region on the priority grid or a subsection of the priority grid. In some embodiments, the distribution 121 indicates the number of information items for a time period for each point in the interval.

The distribution 121 may be represented as a distribution density 123 over the interval or region and a distribution volume or scalar 125. The distribution density 123 may be normalized. In some embodiments, the distribution volume 125 may represent the number of items represented by the distribution. The distribution volume 125 is not required to be a whole number. Distributions may be combined. For example D′=D1+D2 corresponding to the additive combination of frequencies of the distributions D1 and D2, and the combined volume would be N′=N1+N2 and the density of the combined distribution may be re-normalized. Subtraction is also possible subject to considerations on the order of the subtraction and interpretation of the final result.

An empty distribution is a distribution Dₑ where N(Dₑ)=0, X(Dₑ)=0, and Q(Dₑ)=0, and further D+Dₑ=D for all distributions D.

In some embodiments, the distribution of information items 121 may be obtained from an historical accumulation or recording of information items. Numerous techniques specific to the information exchange can be used for recoding the distribution based on historical data. For example using weighted history, rolling average or other computations. The distribution 121 may be computed for each consumer. Multiple distributions are possible and can be used for different purposes in computing other metrics. In some embodiments, aggregations of distributions across information consumers may be used.

In some embodiments, a predicted distribution of information items for a consumer may be computed from one or more historical distributions of information items and optional additional metrics. In some embodiments, the predicted distribution may be computed from metrics alone. The distribution of information items for a specified future period may be predetermined or assigned.

In some embodiments, a master distribution 118 of information items covering a range, interval or space may be used. In some embodiments, the master distribution may cover the entire priority grid. Each sub region contained in the region covered by the master distribution 118 would have a sub distribution. Reference to the sub region may also refer to the sub distribution over the sub region. The points in the sub distribution referenced by the sub region would be the points from the master distribution 118 that are in the sub region. An example of the master distribution is the distribution Dₐₗₗ as referenced in FIGS. 3A and 3B.

In some embodiments, a representative expected item value 127 for the distribution of information items may be computed or assigned. In some embodiments, the representative expected item value 127 may depend on the items represented in the distribution. In some embodiments, a distribution value function 130 transforms the distribution to the representative expected item value 127. Numerous different formulas may be used for the distribution value function 130. For example the value may be computed from the items represented in the distribution as a simple average, weighted average, norm, median, quadratic, or other metric or transformation. As an example, the representative expected item value 127 may be computed as the sum of the consumer item value multiplied by the distribution density value at every point. In some embodiments, other means may be used to compute or assign the representative expected item value 127 for the distribution.

In some embodiments, a potential volume 132 for the distribution is computed as the value obtained from the participation prediction map 115 for the representative expected item value 127 for the distribution. The potential volume 132 may be determined for a single information consumer or from data and metrics for the representative information consumer. The potential volume 132 is not required to be a whole number.

In some embodiments, a requisite expected item value 131 for the distribution is computed as the value obtained from the inverse participation prediction map 116 for the distribution volume 125. The requisite expected item value 131 may be determined for a single information consumer or from data and metrics for the representative information consumer.

In some embodiments, a representative producer item value 134 for a distribution may be computed or assigned. The representative producer item value 134 may depend on the items represented in the distribution. In some embodiments, the representative producer item value 134 for a distribution may be computed as the sum of producer item value for each point in the distribution multiplied by the distribution density at that point, or may be computed as the sum of the value obtained from the priority transformation of the producer priority for each point of the distribution multiplied by the distribution density at that point.

A potential producer value 133 from a consumer for a distribution of information items may be computed or assigned. The potential producer value 133 may depend on the items represented in the distribution. The potential producer value 133 may be computed in numerous different ways from the items represented in the distribution. In some embodiments, the potential producer value 133 for the distribution may be computed as representative producer item value 134 for the distribution multiplied by the potential volume 132 for the distribution.

In some embodiments, multiple distributions can be compared or ranked by evaluating the potential producer value 133 for each distribution. In some embodiments, changes to a distribution 121 may be scored, compared, or ranked by scoring, comparing, or ranking the changes in potential producer value 133 for distributions with and without the change.

A potential volume change 128 between a first and second distribution 121 may be computed. For example, the potential volume change 128 may be determined as the potential volume 132 in the second distribution minus the potential volume 132 in the first. In some embodiments, the potential volume 132 of the second distribution is scaled by the ratio of the volume of the first and second volume. For example, if M and N are the potential volume and volume of the first distribution and M′ and N′ are the same values respectively for the second distribution the projected volume change may be computed as M′-M, or computed as M′N/N′-M. In some embodiments, the potential volume change 128 is determined from other metrics or other projections.

A potential participation rate 129 may be computed as the ratio of the potential volume 132 and distribution volume 125. In some embodiments, the potential participation rate 129 is determined from other metrics or projections.

A potential consumer value 124 may be used to indicate the potential value a consumer may obtain from a specific distribution 121. In some embodiments, the potential consumer value 124 may be computed as the potential volume 132 multiplied by the representative expected item value 127. In some embodiments, the potential consumer value to a consumer may be determined by other means. For example, potential consumer value may be determined by alternative computation, surveys, or other direct measures.

A success metric 140 may be used to determine a degree of proximity or closeness in a computation or ranking or for other similar uses. Success metrics 140 can depend on a single value or on a vector. The success metric may also relate to comparison of two values or vectors. For example, success metrics may be used when comparing proximity, when iterating and accessing a stopping condition, and for managing thresholds, and comparisons in general. Numerous different formulas may be used for determining success metrics 140. The success metric 140 may measure proximity between values or vectors. For example, the measure used may be simple distance, absolute value of distance, ratio, negative penalty, squared difference, cubed difference, norm, or other variations. The result of the metric 140 may be logical, numeric, step function, or other suitable variation. For example, the logical or step function may indicate when a value is above or below a threshold or within a range. When used for ranking or comparing the success metric 140 may indicate either an explicit or implicit preference order. Success metrics may allow for tolerance levels. For example, in thresholds and other comparisons. In some embodiments tolerance levels may be variable. For example, tolerance levels for a specific condition may depend on variables including, for example, degree of proximity in other comparisons or thresholds, other tolerance levels, or related state variables.

An incremental transformation 126 may transform an initial distribution 121 and a specified set of points to create or generate a new distribution 121. The density for each of the points may be different or the same. The transformation may change or set the density for the specified points. The transformation may increase or decrease or hold constant the volume. The transformation may change the region covered by the specified distribution 121. As an example, the transformation may correspond to adding or removing at least part of an information item with information item value pairs for the specified points to the distribution being transformed. In another example, the transformation may preserve the distribution volume after adding or removing the specified set of points and creating a new normalized density for the new distribution, by setting the volume of the new distribution to be the original volume of the specified distribution, and thus maintaining the distribution volume while changing the density.

An expansive incremental transformation 201 expands the region relative to the initial distribution and may also expand the volume. While a reductive incremental transformation 202 reduces the region relative to the initial distribution and may also reduce the volume.

A distribution value change function 203 represents a function of parameters from two distributions mapping to at least one value. The distribution value change may represent, for example, the change from D₁ to D₂. For example in mathematical terms, the distribution value change function 203 can be represented as, Λ (D₁, D₂)→λ where λ is a single numeric value, or for a single point, r={c,p} with volume Nᵣ, Λ (D, r, Nᵣ)→λ, or for two points Λ (r₁, Nᵣ₁, r₂, Nᵣ₂)→λ. In some embodiments, λ may be a vector or other data structure that can be ordered or compared.

An incremental distribution 204 would be the new distribution resulting from the incremental transformation relative to the initial distribution.

The incremental distribution, D′ over region R′, is a preferred incremental distribution 205 for the distribution value change function 203, relative to initial distribution D over region R, such that when expansive, every point in R′→R is preferred to every point not in R′, and any point in R is preferred to every point in R′→R, and when reductive, every point in R′ is preferred to any point in R-R′ and every point in R-R′ is preferred to every point not in R. Where R₁-R₂ indicates the part of region R₁ that is not part of region R₂, and where a point r_{b} is preferred to a point r_{c} when Λ (D, r_{b}, N_{rb})≥Λ(D, r_{c}, N_{rc}) for distribution D.

For a sequence of distributions 206 {D₀, D₁ . . . Dⱼ . . . } where D₀ is the starting distribution for example, a preferred sequence of distributions 207 is a sequence of distributions where for j>0, each Dⱼ is a preferred incremental distribution relative to Dⱼ₋₁.

In some embodiments, the distribution value change function 203 is selected so the potential volume relative to the volume for distributions in the sequence of distributions is monotonically declining. For example, Mⱼ/Nⱼ≤Mⱼ₋₁/Nⱼ₋₁ for j>0.

In some embodiment the distribution value change function 203 is selected so the potential volume for distributions in the sequence of distributions is generally decreasing. For example, M₀>Mⱼ for j>0.

In some embodiments the distribution value change function 203 is the difference in the potential producer value 133 for the specified distribution and the incremental distribution, or a variation of the potential producer value 133. For example, some variations of the potential producer value 133 are
Λ (D, D′)=(the representative producer item value for the specified distribution)*(the distribution volume for the specified distribution) * (the difference of the potential participation rate between the specified distribution and the incremental distribution)+(the representative producer item value for the incremental points)*(the difference of the distribution volume between the specified distribution and the incremental distribution)*(the potential participation rate for the incremental distribution).
Λ (D, D′)=(the representative producer item value for the specified distribution)*(the potential volume change between the specified distribution and the incremental distribution)+(the representative producer item value for the incremental points)*(the difference of the distribution volume between the specified distribution and the incremental distribution)*(the potential participation rate for the incremental distribution).
Λ (D, D′)=[(the representative producer item value for the specified distribution)*(the distribution volume for the specified distribution)+(the representative producer item value for the incremental points)*(the difference of the distribution volume between the specified distribution and the incremental distribution)]*(the potential participation rate for the incremental distribution).

Composites of the above variations may also be variations of the potential producer value 133 for the specified distribution and the incremental distribution.

An example of a variation of the potential producer value 133 when the incremental distribution is represented by a single point:
Λ (D, r, Nᵣ)=F(c|D)+H(p)*G(c|D), where in this formula D is the specified distribution, r={c, p} is a point, c is consumer priority or consumer item value at the specific point, and p is the producer priority or producer item value at the specific point. Further, F(c|D) is a function or mapping of c with parameters determined from the specified distribution, D, and with properties that F is monotonically increasing in c over the relevant range around the specific point; H(p) is a function or mapping of p with properties that H<0 if p<0, and H>0 if p>0, and H is monotonically increasing; H may also depend on Nᵣ; and G(c|D) is a function or mapping of c with parameters determined from the specified distribution and with properties over the relevant range around the point such that, if Nᵣ is greater than the distribution volume 125 for the specified distribution that G is monotonically increasing and otherwise monotonically decreasing.

### Star Distribution

A distribution may be a star distribution when the distribution potential volume 132 is approximately equal to the distribution volume 125. The criteria for a star distribution may be determined by a success metric. For example, a success metric may indicate where the potential volume 132 relative to the volume 125 crosses a threshold, or where the potential volume 132 is approximately equal to the volume 125. The threshold in this case is an example of a potential volume threshold 220, and the potential volume threshold is met when indicated so by a success metric or when the two sides of the inequality involving a potential volume is approximately equal.

In some embodiments, the star distribution is from the preferred sequence of distributions 207. In some embodiments, if more than one distribution from the sequence of distributions 207 meets the success metric criteria for the star distribution the distribution with the largest volume 125 is selected.

In some embodiments, the processing for determination of the star distribution coincides or occurs as part of the processing for the determination of at least part of the preferred sequence of distributions 207.

In some embodiments, the processing of the preferred sequence of distributions 207 is done before the determination for the star distribution.

The symbol D*, for example, represents a distribution that meets the star distribution criteria.

FIGS. 3A and 3B illustrate example use cases of D* in the distributor subsystem. Improvements to the processing of Dₐₗₗ 304 improve the operation of the distributor subsystem 52 and in turn provide for improvements to the information exchange system 29 as well.

In FIG. 3A predicted items 301 for a consumer are used to construct the data structure for Dₐₗₗ 302. In some embodiments, the predicted items may already be in a data structure representing Dₐₗₗ. In some embodiments, the data structure for the predicted items may also include other metrics to facilitate the construction of Dₐₗₗ or also the determination of D*. The Dₐₗₗ is then processed to determine D* and R* 304 and the data structure for R* 306 is used to filter information items 24 to be included into the information stream 25.

In FIG. 3B candidate items 311 for a consumer are used to construct the data structure for Dₐₗₗ 302. In some embodiments, the candidate items may already be in a data structure representing Dₐₗₗ. In some embodiments, the data structure for the predicted items may also include other metrics to facilitate the construction of Dₐₗₗ or also the determination of D*. The Dₐₗₗ is then processed to determine D* 304, and D* 316 represents the items to be transferred 318 to the information stream 25. The information items from D* 316 may be transferred in real time or delayed.

A distribution of information items with candidate items may be referenced as a candidate distribution, and a distribution of information items with predicted items may be referenced as a predicted distribution.

### Determining D*

In this Specification the notation N(D) represents the volume 125 of distribution 121 D, and M(D) represents the potential volume 132 of distribution 121 D.

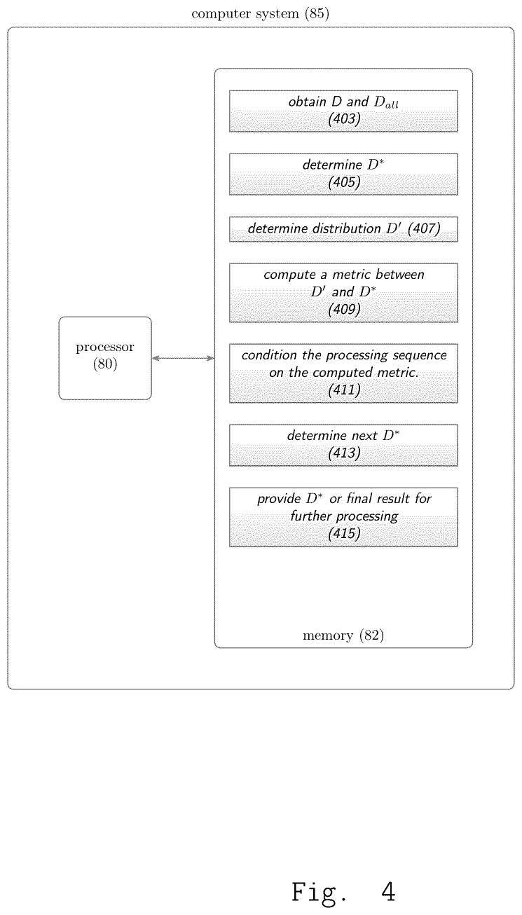

FIG. 4 illustrates an example of a computer system 85 with at least one processor 80 and memory 82. The memory 82 is configured to store instructions that are executed by one or more processors. The execution of those instructions provides, for example, a means for determining D*, and may be used, for example, in the systems illustrated in FIGS. 3A and 3B as the process to determine D* 304.

The system obtains the initial D and Dₐₗₗ 403, where D and Dₐₗₗ are data structures also stored in memory. There are multiple ways to obtain D and Dₐₗₗ via memory, direct input from another process or system, an external data storage medium, or other means of transferring data structures to memory to be processed.

The obtained D and Dₐₗₗ are used, for example, to processes the code for determining the D* 405. The distribution D′ is determined 407, for example, relative to the current D*. There are variations on what D′ includes and how D′ is determined. For example, D′ may be the next distribution in a preferred sequence of distributions 207, or the next distribution after D* may be the preferred incremental distribution 205, and there are variations for the determination of the preferred incremental distribution 205 resulting from the variations of the distribution value change function 203. In one example, the distribution value change function 203 may be the potential producer value 133. There are multiple variations on the potential producer value 133 as detailed in this spec and further variations when different variations are combined as a composite.

In one example, D′ may be the first preferred incremental distribution 205. In other examples, additional preferred incremental distributions may be evaluated to determine D′. For example, a metric between D* and the additional distributions in the preferred sequence may be compared to determine the distribution to select as D′, that metric may be the slope metric. However, it may be a different success metric 140. For example, if a metric similar to the ratio of M(D′)-M(D) and N(D′)-N(D) is increasing with the next possible D′, then subsequent D′ should be used until said metric is no longer increasing.

The system computes a slope metric between D* and D′ 409, and uses the slope metric as a condition to determine the processing sequence. The computation of the slope metric may be, for example, computed by formula (M(D′)-M(D*))/(N(D′)-N(D*)) or similar variations of that formula. The conditions on the processing sequence may be, for example, when the metric is ≤0 the current D* is provided for further processing 415, and when the slope metric is >0 and <1, the D′ is altered to meet a success criteria. Other similar conditions producing similar results, may also be used.

The structure for altering D′ to meet a success criteria, may correspond with the system for generating a carve-out distribution and using that distribution to alter D′, and the altered D′ may meet the criteria for a star distribution. The altered D′ may be the result even if the criteria for a star distribution was not met.

In some embodiments, additional processing detects or has data to indicate that the distribution value change function 203 is known to be monotonically decreasing and the processing to determine distribution D′ (407) and also processing for 411 automatically passes to 415. The final D* or final result, for example as a data structure, may be provided in memory, or transferred to other processes, for further use.

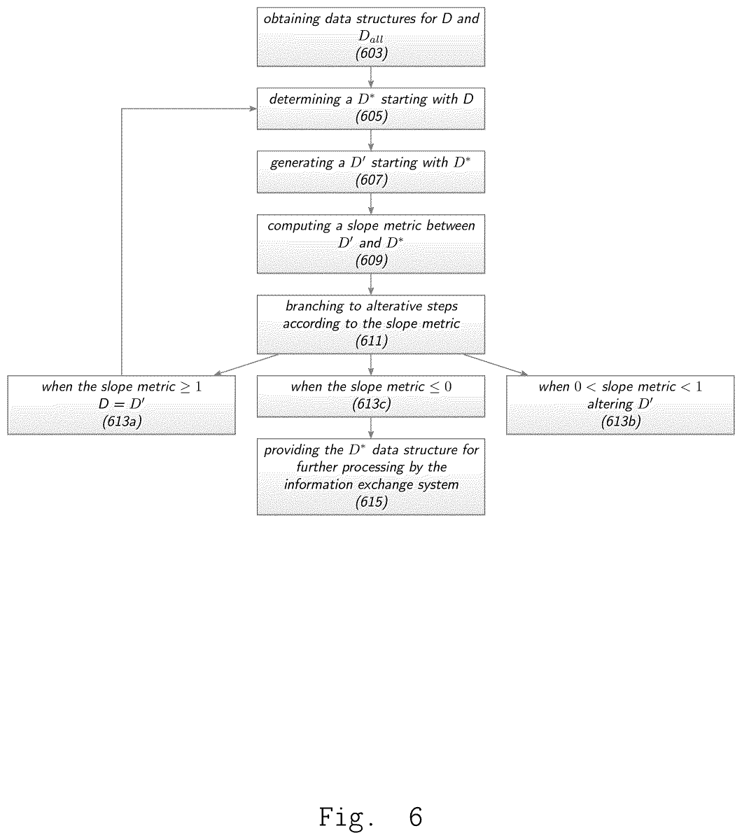

FIG. 6 is an illustrative example of steps in a process for determining D*. The method functions by obtaining data structures for distribution D and master distribution Dall 603 and determining distribution D* starting with distribution D 605. After determining D*, the method proceeds with generating distribution D′ 607 and computing a slope metric between D* and D′ 609. Next, the step of branching to alternative steps according to the slope metric 611. When the slope is negative the next step is proceeding with the current D* 613c, and when the slope is positive and <1 the next step is to alter D′ 613b, and when the slope is ≥1 the next step is to go back to the step to determine D* 613a where the D is set to the value of D′.

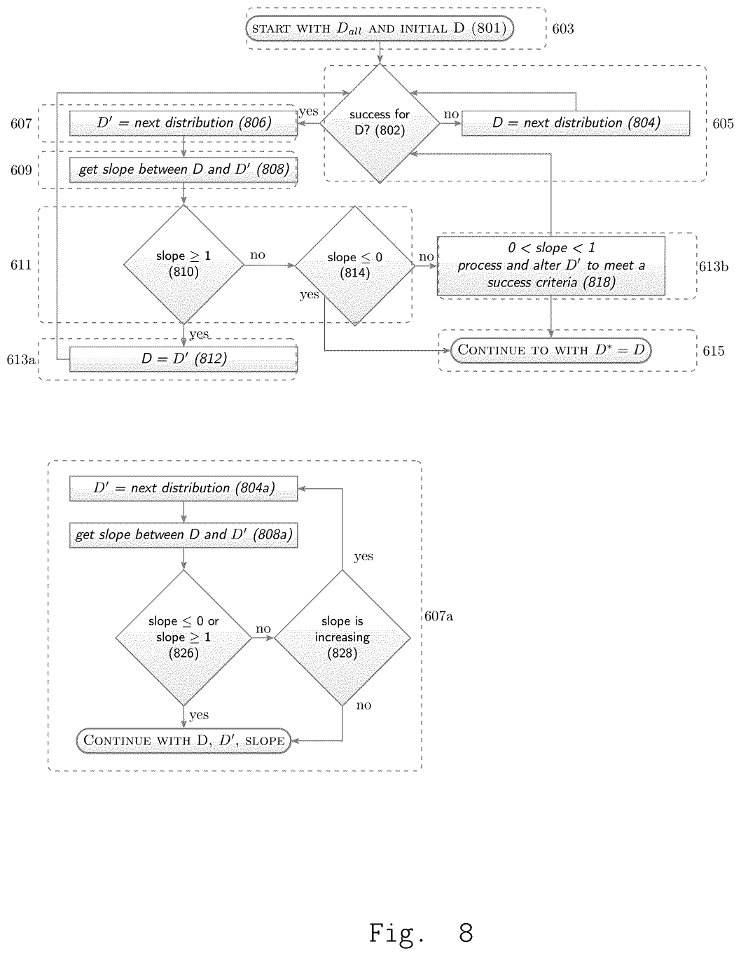

FIG. 8. is an illustrative example of some of the possible details of each functional step in a process for determining D* as in FIG. 6. FIG. 8 is an example only to show multiple variations within the structure of FIG. 6. The initial distribution D may be D₀ or Dₐₗₗ or any preselected distribution 121 such that D is a subset of Dₐₗₗ, D⊂Dₐₗₗ. A decision process 802 checks if the functions M(D) and N(D) are close enough according to a success metric. If success criteria is not met a next distribution is determined 804. The next distribution 804 may be an incremental distribution change. The next distribution 804 may also be the next distribution from a preferred sequence of distributions 207 or the next distribution 804 is determined by other means.

If success criteria is met, a next distribution is determined 806. This corresponds to the 607 step in FIG. 6. In one example the next distribution 806 and the next distribution 804 are the same. In some embodiments, the next distribution 806 would be the distribution with the highest slope when 0<slope <1, where the slope is for example, [M(D′)-M(D)]/[N(D′)-N(D)]. Other alternative measures for the slope between D and D′ are possible. In some embodiments, the next distribution 806 is a multi incremental distribution change. In some embodiments, the next distribution 806 gets the slope between between D and D′ and if the slope is in a specific range 826, for example, 0<slope<1, it will continue to get an additional next distribution until a criteria has been met 828. See the 607a option in FIG. 8 for the 607 step in FIG. 6.

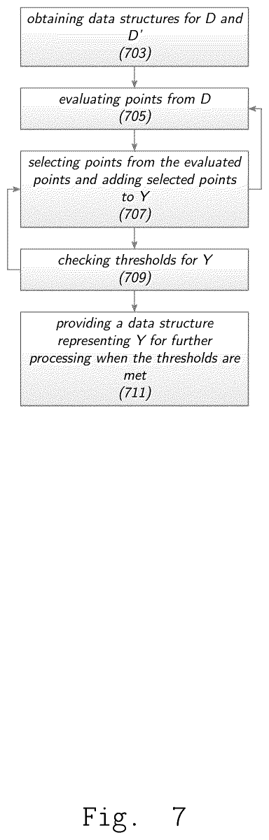

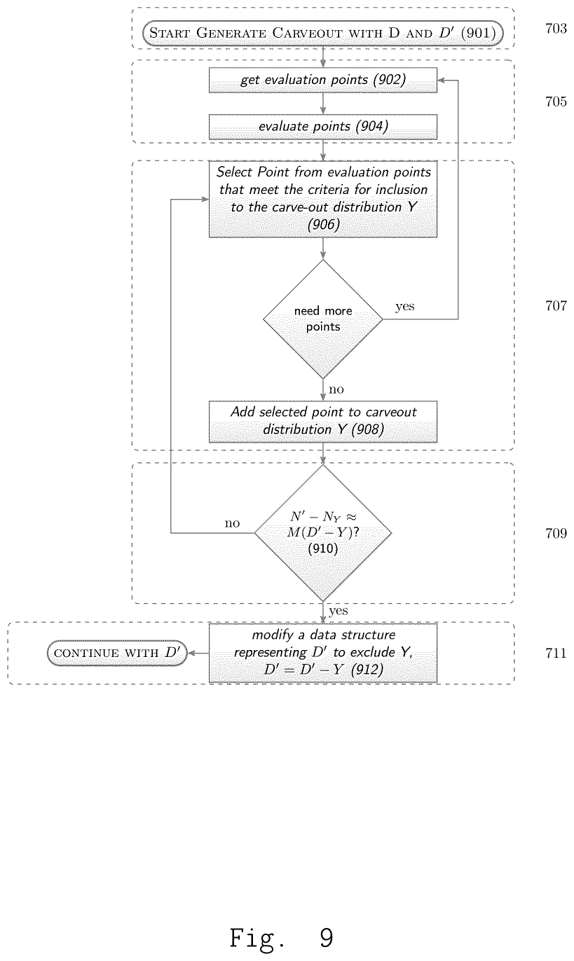

When the slope >1 the distribution D′ becomes input to the check for success 802. When the slope ≤0 the D* has been determined. When 0<slope<1 further processing and a check of thresholds on the slope may be computed to determine if the process should stop 818. When stopped, D* may be set to either D or D′. The setting of D* to D′ or an altered D′ is not shown in FIG. 8. If not stopped, further processing will alter D′ to meet a success criteria. In some embodiments a carve-out is determined and D′ is adjusted to create an alternative D*, for example, as in FIG. 7 or FIG. 9. Optionally, the altered D′ may be further processed by 802 as shown by the connector between 818 and 802. In some embodiment, the system of FIG. 8 completes the process for determining D* and R* in FIG. 3A and FIG. 3B.

When the initial distribution D has a potential volume 132<the volume 125 the incremental transformation to the next distribution may be reductive or when the next distribution comes from the sequence of distribution it may be the distribution that is a subset of the current distribution.

When the incremental transformation in the next distribution 804 is reductive, the distribution with highest potential volume may be tracked, and the tracked distribution may be set to D′ in step 607.

### Improving a Distribution

A carve-out distribution Y may be determined so that a new distribution D′ may be generated or created so that D′=D−Y where distribution D is the initial distribution and D may be a star distribution. The new distribution D′ may meet the criteria for a star distribution.

In mathematical expressions, the distribution value function 130 is denoted as Q. So for example the distribution value function 130 for distribution D is Q(D).

The carve-out distribution is useful, for example, when there is a star distribution, D*, and there exits an additional distribution 121, B, such that Q(D*)<Q(B), and distribution D′=D*+B does not meet the criteria to be a star distribution.

This will occur in 613b case of FIG. 6 and FIG. 8 where 0<slope<1. Another possible scenario the need for a carve-out distribution is when B contains meta data new to the consumer or new to the information exchange, and it is given an artificial distribution value slightly above the average so the meta data can be tested by some consumers.

In some embodiments, the distribution B may only represent a single point. The volume for a single point r may be represented as Nᵣ.

The distribution Y may satisfy a consumer condition 221 and may satisfy a producer condition 222. A consumer floor condition 223, for example, is such that: Σ_{(∀}_{ᵣ}_{∈Y)} cᵣ Nᵣ≤Q(B)N(B). In words the sum of the consumer priority times the volume for each point in Y is less than or equal to the product of the distribution value function 130 for B and the distribution volume 125 for B. In some embodiments, a tolerance level on the consumer floor condition is allowed. For example, when a tolerance factor is added to the right hand side of the inequality in the consumer floor condition 223.

A producer floor condition 224, for example, is such that: Σ_{(∀}_{ᵣ}_{∈Y)} vᵣ Nᵣ≤X(B)N(B) where vᵣ is the producer priority transformation 114 for the point, and X is the representative producer item value 134 and N(B) is the volume 125 for distribution B, and in words the sum of the producer priority transformation 114 times the volume for each point in Y is less than or equal to the product of the representative producer item value 134 for B and the distribution volume for B. In some embodiments, a tolerance level on the producer floor condition is allowed. For example, when a small tolerance factor is added to the right hand side of the inequality in the producer floor condition 224.

In some embodiments, success metrics 140 may be used to control the threshold with tolerances for the producer condition and the consumer condition.

In some embodiments, the consumer condition 221, may be the consumer floor condition 223.

In some embodiments, the producer condition 222, may be the producer floor condition 224.

In some embodiments, the point with the lowest c meeting the consumer condition and the producer condition is selected before other points.

In some embodiments, the point selected must have a c value below a c threshold. For example the c threshold may be set to Q(B) or Q(D).

A stopping threshold for Y 227, for example, may be met when N(D′−Y)˜M(D′−Y). A success metric may be used to determine, for example, when the threshold is met within a tolerance level. Similar comparisons, for example N(D′)−N(Y)≅M(D′−Y) and similar equivalents, can also be used to obtain similar results.

Different tolerance levels may be set on the consumer condition, producer condition, or stopping threshold for Y to prioritize greater restrictions on the consumer condition, producer condition, or stopping threshold for Y.

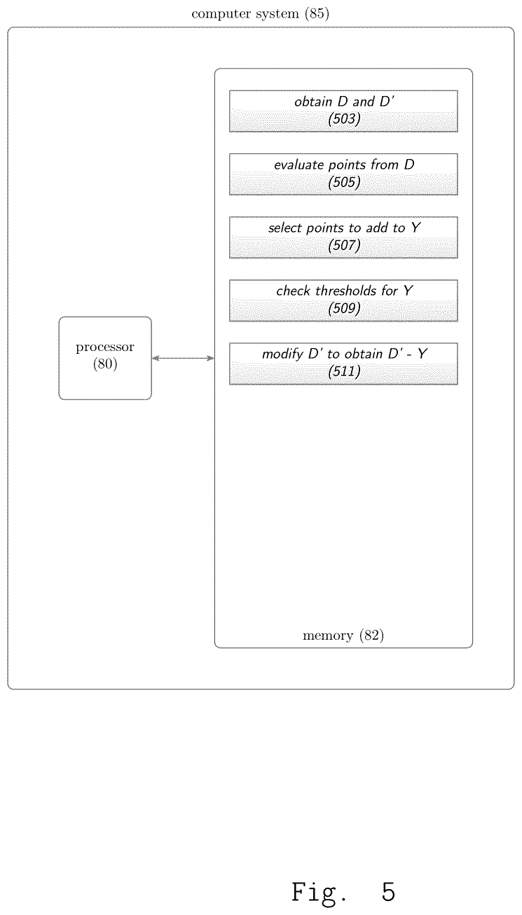

FIG. 5 illustrates an example of a computer system 85 with at least one processor 80 and memory 82. The memory 82 stores, for example, instructions that are executed by one or more processors, and when executed the instructions provide, at least some of the functions in, for example, in FIGS. 4, 411, and in FIG. 6, as altering D′ to meet a success criteria 613b.

The system in FIG. 5 obtains D and D′ 503, for example, as data structures in memory, and processes the data structures for D and D′ to produce a modified D′ that will meet the criteria for a star distribution. There are multiple ways to obtain D and D′ via memory, direct input from another process or system, external data storage medium, or other means of transferring data structures to memory to be processed.

The computer system 85 may be configured, for example, to evaluate points from D 505 and, determine points to add to Y 507, where the determined points may be from the evaluated points. The points to add to Y, for example, may be determined by ranking or comparing the evaluated points. In some embodiments, the evaluating and selecting may be completed simultaneously.

In some embodiments, the points added to Y meet the consumer condition 221 and the producer condition 222. In some embodiments, success metrics for the consumer condition 221 and producer condition 222 may be used to select points within the tolerance levels for the consumer condition 221 and producer condition 222. In some embodiments, the points to add to Y, may be determined by including the points with the least total volume according to the success metric for the stopping threshold for Y 227, and the success metric may consider a tolerance level for the stopping threshold 227.

In some embodiments, the result may be the data structure Y 511. In some embodiments, the result may be the data structure for distribution D′−Y 511, where computationally the points in Y are removed from a data structure representing D′ to yield the data structure for D′−Y 511. The processing may directly modify the initial data structure for D′. In some embodiments, the processing may alternatively bypass the step to add selected points to Y, and directly remove the points from D′ and use a modified stopping condition N(D′)≅M(D′) or the potential volume threshold 220.

An alternative configuration yielding similar results to the system in FIG. 5, would be a system configured to obtain D and D′, evaluate points from D, generate Y, where evaluated points are selected to meet producer conditions and consumer conditions, and selected points are added to Y until the stopping threshold for Y is met. The result being a data structure representing Y.

In some embodiments, the points to add to Y, may be determined, to minimize any negative impact on the producer unit value in the resulting distribution D′−Y distribution relative to the initially obtained D distribution. This may be realized using the producer floor condition 224 with appropriate tolerance levels on the producer condition 222 and consumer condition 221 and the stopping threshold. The appropriate tolerance levels may be obtained by trial and error evaluation of different tolerance levels to see what produces the minimal tolerance level for the producer condition.

The computer system 85 in FIG. 5 may be the same as, or different from, the computer system in FIG. 4.

A general illustrative description for an example method of generating the carve-out distribution Y:
1. Start with distributions D and D′.
2. Y may be initially set to the empty distribution.
3. Get evaluation points from D.
4. Select points that meet the consumer condition 221 and producer condition 222.
5. Add each point selected to Y until the stopping threshold 227 is met.
6. When the threshold for Y 227 is met, proceed with, or return, the data structure for the D′−Y distribution.

In some embodiments, when getting the evaluation points in step 3 of the example above, points adjacent to interior boundary may be evaluated first, followed by points adjacent to the points that are adjacent to the points on the interior boundary. In some embodiments any of the points may be evaluated.

FIG. 7 is an illustrative example of steps in a process for determining a carve-out distribution. The method functions by obtaining data structures for D and D′ 703, evaluating points from D 705, selecting points from evaluated points to add to Y 707, checking thresholds for Y 709, and providing a data structure representing Y for further processing when the thresholds are met 711.

In the illustrative example of FIG. 9, a process for determining the carve-out for D′ starts with initial distributions for D and D′ 901. The relation between D and D′ is such that distribution D′=D+B Q(D)<Q(B). The initial D may be, for example, the D* from the system for determining D* as in FIG. 6. The step for evaluating points from D 705, may include getting the initial evaluation points 902. The evaluation points may be the points on the interior boundary of region R associated with D. The evaluation point may also include, for example, points that would be on the boundary if boundary points were removed. In some embodiments any of the points in the region R may be selected as evaluation points. Corresponding with the step 707 in FIG. 7, points from the evaluated points are selected in order, if no points meeting the producer condition or consumer condition, the method will get more evaluation points, otherwise it will add the points in order to distribution Y 908. Corresponding with step 709 in FIG. 7, if the stopping threshold for Y is not met the process will continue selecting the next point, otherwise it will modify a data structure representing D′ to exclude Y 912.

In summary, the example in FIG. 9 will process the data structures for D and D′ to produce a modified D′ that will meet the criteria for a star distribution. The process will evaluate points from D 902, select points meeting the criteria for inclusion to the carve-out distribution 906, and generate the carve-out distribution 908 with consideration to the stopping threshold for Y 910.

### Conclusion

The systems and methods described here are applicable to existing information exchanges or as basis for new information exchanges to improve effectiveness and efficiency.

Examples and variations given in this specification are not limiting and other examples, combinations, and variations will be apparent to those skilled in the art.

What is claimed:

1. A computer system for generating a carve-out distribution used to improve the control of an information stream of at least one information consumer, comprising: memory and a processing means configured to:
obtain a first distribution D and a second distribution D′, wherein distribution D′ has a greater distribution value than D;
evaluate one or more points from D;
select points to add to a carve-out distribution Y, where the points are selected from the evaluated points;
check one or more thresholds for Y;
obtain a modified D′, wherein the carve-out distribution Y meets at least one threshold, and wherein the modified D′ is D′−Y.

2. The computer system of claim 1, wherein the modified D′ is used in the determination of a star distribution, and wherein the star distribution is used in the determination of the information items included into the information stream of at least one information consumer.

3. The computer system of claim 1, wherein the second distribution D′ is an incremental distribution relative to the first distribution D.

4. The computer system of claim 1, wherein the second distribution D′ is a preferred incremental distribution relative to the first distribution D.

5. The computer system of claim 1, wherein the second distribution D′ is an expansive incremental distribution relative to the first distribution D.

6. An information exchange method for generating a carve-out distribution used to improve the determination of the information items to be included into the information stream of at least one information consumer, comprising:
a first distribution D;
a second distribution D′, wherein D′ has a greater distribution value than D;
evaluate points from D, wherein the points are evaluated at least in part by the consumer or producer priority of the point;
select points to add to the carve-out distribution Y, wherein the points are selected from the evaluated points by rank or comparison;
check the thresholds for the carve-out distribution Y;
generate a modified D′, wherein the modified D′ is the second distribution D′ minus the points in Y;
whereby the modified D′ is used to determine a star distribution, and wherein the star distribution determines the set of information items that are added to the information stream for at least one information consumer, or wherein the modified D′ is used as an alternative to the star distribution.

7. The method of claim 6, further comprising:
determine a star distribution, wherein the star distribution is determined at least in part using the D′.
determine the information items that are added to the information stream of at least one information consumer, wherein the star distribution is used in the determination.

8. The method of claim 6, wherein the second distribution D′ is an incremental distribution relative to the distribution D.

9. The method of claim 6, wherein the second distribution D′ is a preferred incremental distribution relative to the first distribution D.

10. The method of claim 6, wherein the second distribution D′ is a expansive incremental distribution relative to the first distribution D.

11. The method of claim 6, wherein the modified D′ meets the criteria for a star distribution.

12. The method of claim 6, wherein the selected points meet the consumer condition.

13. The method of claim 6, wherein the selected points meet the producer condition.

14. The computer method of claim 6, wherein the selected points meet the potential volume threshold;

15. The computer method of claim 6, wherein the selected points meet the stopping threshold;

16. A recommender system filtering items for at least one information consumer, comprising:
an information stream, wherein the information stream is a collection or set of recommendations or other information items delivered sequentially or together to a consumer;
a candidate distribution consisting of candidate information items;
a subsystem configured to use the method of claim 6 to generate a modified D′, and use the modified D′ determine a star distribution, and further use the star distribution to filter recommendations from the candidate content to be included into the information stream.

17. A non-transitory computer readable medium storing instructions executable by at least one processor of a computer system to cause the computer system to at least:
obtain data structures for an initial distribution D and a master distribution Dall;
determine a star distribution starting with distribution D;
generate an expansive incremental distribution D′ from the star distribution;
compute a slope metric between D′ and the star distribution;
generate an altered distribution D′ when the slope metric >0 and <1, wherein the altered distribution is used to determine a subsequent star distribution.

18. The non-transitory computer readable medium of claim 17, further storing instructions executable by at least one processor of a computer system to cause the computer system to:
use the subsequent star distribution to determine to include information items in an information stream of at least one information consumer.

19. The non-transitory computer readable medium of claim 17, wherein when the slope metric >0 and <1 a carve-out distribution is used to generate the altered distribution.

20. The non-transitory computer readable medium of claim 17, wherein a preferred sequence of distributions starting with distribution D is generated until a star distribution is determined from the sequence.
